(19) United States
(12) Patent Application Publication
(10) Pub. No.: US 2015/0220680 A1
(43) Pub. Date: Aug. 6, 2015

(54) INFERRING BIOLOGICAL PATHWAYS FROM UNSTRUCTURED TEXT ANALYSIS

(71) Applicant: International Business Machines Corporation, Armonk, NY (US)

(72) Inventors: STEPHEN K BOYER, SAN JOSE, CA (US); JEFFREY T KREULEN, SAN JOSE, CA (US); W SCOTT SPANGLER, SAN MARTIN, CA (US)

(73) Assignee: International Business Machines Corporation, Armonk, NY (US)

(21) Appl. No.: 14/170,373

(22) Filed: Jan. 31, 2014

(51) Int. Cl. G06F 19/12

(52) U.S. Cl. CPC G06F 19/12

(57) ABSTRACT

A biological pathway is a series of actions that take place in an organism that lead to some resulting pathology or otherwise change the organism state. In the cell, these actions typically take place between molecules called proteins. Proteins within the cell interact in ways that are not fully understood, but evidence concerning these interactions is constantly being collected and published by microbiologists. The disclosed method automatically infers such biological pathways between proteins by looking at the overall system of published literature about those proteins.

### BACKGROUND OF THE INVENTION

1. Field of Invention

The present invention generally relates to inferring biological pathways. More specifically, the present invention is related to a system, method and article of manufacture for inferring biological pathways from unstructured text analysis where such inference may be based on literature analysis or based on vector analysis of entities in literature (i.e., literature based discovery).

2. Discussion of Related Art

The ability to summarize and visualize biological information as a pathway is a well-known and long studied problem. The current best approach to solving this problem relies on manually curated networks such as the Kyoto Encyclopedia of Genes and Genomes (KEGG) network. But these networks are necessarily incomplete and may miss some implicit connections between biological entities that are not yet experimentally validated.

The prior art does not, however, disclose an approach that connects a given set of proteins using a relative neighborhood graph and then visualizes this graph in such a way that the relationships between the nodes can be easily inferred from interactive queries on the visualization itself.

Embodiments of the present invention are an improvement over prior art systems and methods.

### SUMMARY OF THE INVENTION

Disclosed is an approach that connects a given set of proteins using a relative neighborhood graph and then visualizes this graph in such a way that the relationships between the nodes can be easily inferred from interactive queries on the visualization itself. The goal is both to mirror the biological system with an entity relationships graph, and to reveal and organize the information space at the same time. This provides a hypothesis along with the rationale behind the hypothesis at the same time.

In one embodiment, the present invention provides a method for discovering a pathway (e.g., a biological pathway, a chemical pathway, a mechanistic pathway, or a metabolic pathway (where, mapping of a specific transitional modification (reaction) is discovered at a specific site on the metabolic pathway)) among a set of biological/chemical entities (e.g., protein, gene, disease, etc.), wherein the method comprises: (a) providing documents about each of the biological/chemical entities; (b) creating a vector space representation of the documents based on words and/or phrases occurring in the documents; (c) for each biological/chemical entity, creating a centroid in the vector space based on the vectors corresponding to documents mentioning that entity; (d) creating a relative distance network (e.g., a mathematical network based on mathematical computations) of the biological/chemical entities, in view of the centroids, thereby identifying a particular pathway connecting the centroids; and (e) finding at least one most connected centroid on the particular pathway, thereby identifying a particular entity for further investigation, wherein the particular entity corresponds to the at least one most connected centroid.

In another embodiment, the present invention discloses a method comprising: (a) receiving a set of biological and/or chemical entities of interest, E; (b) identifying a document set, R, mentioning any biological and/or chemical entity, and/or a variant thereof, in E; (c) creating a dictionary, D, from common terms and/or phrases in documents of document set, R; (d) assigning each document in document set R a numeric vector using a vector space model based on the dictionary D; (e) computing a centroid for each biological and/or chemical entity in E by averaging numerical vectors of documents in R mentioning that entity; (f) computing a distance matrix listing a distance between pairs of centroids; (g) creating a relative neighborhood graph of biological and/or chemical entities in E based on the computed distance matrix, the relative neighborhood graph identifying a particular pathway connecting computed centroids; and (h) identifying, from the relative neighborhood graph, at least one most connected centroid and outputting biological and/or chemical entity associated with the at least one most connected centroid.

In another embodiment, the present invention discloses a non-transitory, computer accessible memory medium storing program instructions for discovering a pathway among a set of biological and/or chemical entities, wherein the program instructions are executable by a processor to: (a) receive a set of biological and/or chemical entities of interest, E; (b) identify a document set, R, mentioning any biological and/or chemical entity, and/or a variant thereof, in E; (c) create a dictionary, D, from common terms and/or phrases in documents of document set R; (d) assign each document in document set R, a numeric vector using a vector space model based on the dictionary D; (e) compute a centroid for each biological and/or chemical entity in E by averaging numerical vectors of documents in R mentioning that entity; (f) compute a distance matrix listing a distance between pairs of centroids; (g) create a relative neighborhood graph of biological and/or chemical entities in E based on the computed distance matrix, the relative neighborhood graph identifying a particular pathway connecting computed centroids; and (h) identify, from the relative neighborhood graph, at least one most connected centroid and outputting biological and/or chemical entity associated with the at least one most connected centroid.

In another embodiment, the present invention discloses a system for discovering a pathway among a set of biological/chemical entities, the system comprising: one or more processors; and a memory comprising instructions which, when executed by the one or more processors, cause the one or more processors to: (a) receive a set of entities of interest, E; (b) identify a document set, R, mentioning any entity, and/or a variant thereof, in E; (c) create a dictionary, D, from common terms and/or phrases in documents of document set, R; (d) assign each document in document set, R, a numeric vector using a vector space model based on the dictionary, D; (e) compute a centroid for each entity in E by averaging numerical vectors of documents in R mentioning that entity; (f) compute a distance matrix listing a distance between pairs of centroids; (g) create a relative neighborhood graph of entities in E based on the computed distance matrix, the relative neighborhood graph identifying a particular pathway connecting computed centroids; and (h) identify, from the relative neighborhood graph, at least one most connected centroid and outputting entity associated with the at least one most connected centroid.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 depicts an example method as per the teachings of the present invention.

FIG. 2 depicts a vector space representation according to relative positions of documents in space.

FIG. 3 depicts centroids created around each entity based on finding the average vector of all the vectors for that gene.

FIG. 4 depicts a network that is created between the genes by creating a relative network graph that connects the genes that are most similar to each other.

FIG. 5 depicts the graph of the set of entities mapped as per the teachings of the present invention.

FIG. 6 depicts the generated graph to identify areas of interest.

FIG. 7 depicts a non-limiting example of a system implementing the method of the present invention.

### DESCRIPTION OF THE PREFERRED EMBODIMENTS

While this invention is illustrated and described with respect to preferred embodiments, the invention may be produced in many different configurations. There is depicted in the drawings, and will herein be described in detail, preferred embodiments of the invention, with the understanding that the present disclosure is to be considered as an exemplification of the principles of the invention and the associated functional specifications for its construction and is not intended to limit the invention to the embodiments illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

Details of the Methodology

First, the basic approach is described where this approach can be applied whenever there is a set of biological and/or chemical entities, each mentioned in numerous text documents. In the preferred embodiment, entities as used herein refers to tangible, biological and/or chemical concepts of material existence, such as genes and proteins. Then, a detailed algorithm is described to implement this approach and produce the visualization with the desired properties.

High Level Description

The process of building an entity tree (showing network entity relationships) begins with finding the text documents within a set of documents that mention each biological entity of interest. These documents are then converted into numeric vectors by discovering and then applying a dictionary of words and/or phrases. These vectors can then be averaged for each biological/chemical entity to create a centroid (see for example, U.S. Pat. No. 8,606,815, also assigned to International Business Machines Corporation, for an example of how such centroids are calculated). The centroids can then be strung together in a relative neighborhood graph which creates a minimal spanning tree between the entities. Finally, the centroids and their associated documents can be visualized in a scatter plot graph, whose axes are determined by finding two principal component vectors in the matrix of centroids. A detailed description of this algorithm is now provided.

Detailed Algorithm

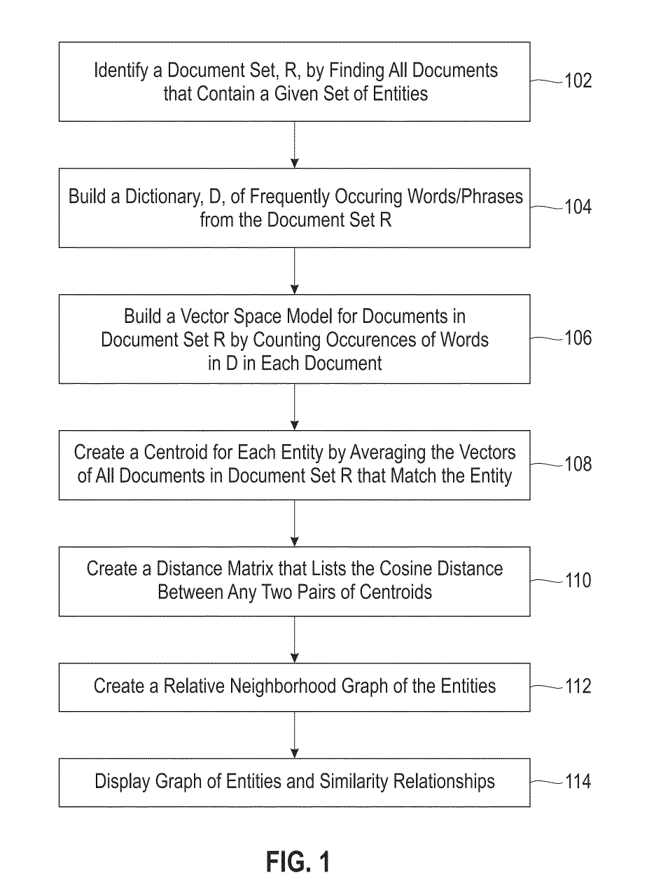

As depicted in FIG. 1, in step 102, given a set of biological and/or chemical entities, a set of documents, R, that contain a given set of entities is located. In one embodiment, the set of documents may be obtained as a result of an execution of a query. In an extended embodiment, the name variants of the entities (e.g., synonyms for each entity) can be submitted as part of the query, where the set of documents matching the query terms is returned. In another embodiment, documents that match more than one entity may be eliminated from consideration. In yet another embodiment, entities which have too few documents (less than a pre-defined threshold N) can be eliminated from consideration.

In step 104, a dictionary, D, is built from frequently occurring words/phrases from R.

In step 106, a vector space model is built for documents in document set R by counting occurrences of words in D in each document in R. U.S. Pat. No. 8,606,815, also assigned to International Business Machines, provides an example of how documents may be represented in a vector space model. In such a representation, each document is represented as a vector of weighted frequencies of the document features (words and/or phrases). The txn weighting scheme is used as described in the paper to Salton et al. titled “Term-Weighting Approaches in Automatic Text Retrieval” (source: Information Processing & Management, Vol. 24, No. 5, pp. 513-523, 1988). This scheme emphasizes words with high frequency in a document, and normalizes each document vector to have unit Euclidean norm. For example, if a document were the sentence, “We have no bananas, we have no bananas today,” and the dictionary consisted of only two terms, “bananas” and “today”, then the unnormalized document vector would be {2 1} (to indicate two bananas and one today), and the normalized version would be:

$$[ 2 / \sqrt{5} , 1 / \sqrt{5} ] .$$

The words and/or phrases that make up the document feature space are determined by first counting which words occur most frequently (in the most documents) in the text. A standard “stop word” list is used to eliminate words such as “and”, “but”, and “the”. The top N words are retained in the first pass, where the value of N may vary depending on the length of the documents, the number of documents, and the number of categories to be created. Typically N=2000 is sufficient for 10000 short documents of around 200 words to be divided into 30 categories. After selecting the words in the first pass, a second pass is made to count the frequency of the phrases that occur using these words. A phrase is considered to be a sequence of two words occurring in order without intervening non-stop words. Pruning is again done to keep only the N most frequent words and/or phrases. This becomes the feature space. A third pass through the data indexes the documents by their feature occurrences. The user may edit this feature space as desired to improve clustering performance. This includes adding in particular words and/or phrases the user deems to be important, such as “International Business Machines”. Stemming is usually also incorporated to create a default synonym table that the user may also edit.

In step 108, a centroid is created for each entity by averaging the vectors of all documents in R that match the entity.

In step 110, a distance matrix is created that lists the distance (e.g., cosine distance) between any two pairs of centroids.

In step 112, a relative neighborhood graph of the entities, E, is created as follows: (a) a candidate set, C, is created containing all entities in E; (b) an initial entity is selected and removed from C to be added as a node, e, to a tree; (c) in order to find the next node to add to the tree, all remaining entities in C (those not yet in the tree) are compared to all nodes in the graph based on the distance information in the created distance matrix, and the entity not in the tree with the shortest distance to a node, c, in the candidate set is identified and added to the tree where a link between c and the new node e is added. Next, c is removed from the candidate set and the process is iterated until all entities in E are added somewhere in the tree.

Lastly, graph of entities and similarity relationships are displayed in step 114.

### Example

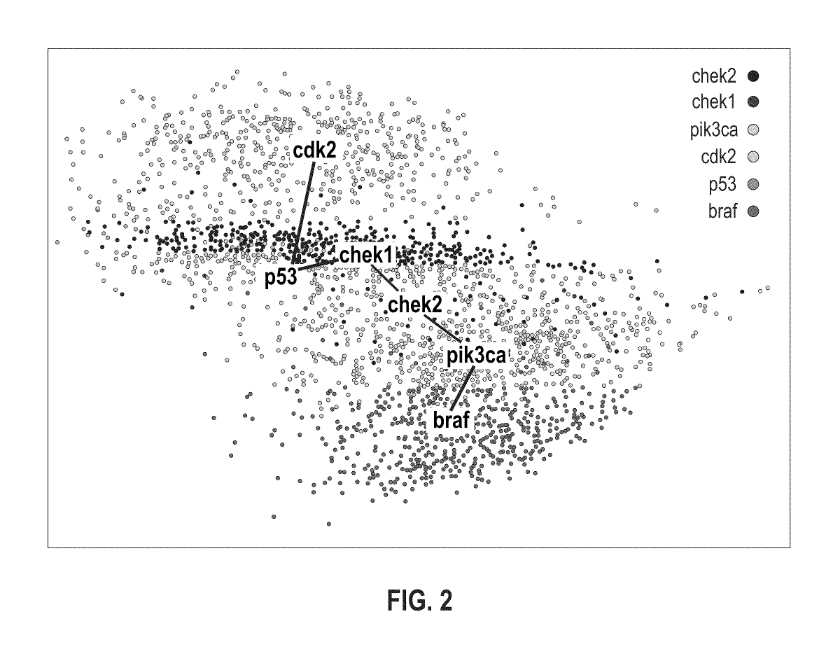

One example of creating a biological pathway from unstructured information is around the disease query of colon cancer. Looking across all Medline® abstracts, it is noted that the following six genes co-occur frequently with colon cancer in Medline® abstracts: chek2, chek1, pik3ca, cdk2, p53, and braf. A vector space representation of these Medline® abstracts is created and a graph is generated as described previously according to their relative position in space as shown in FIG. 2.

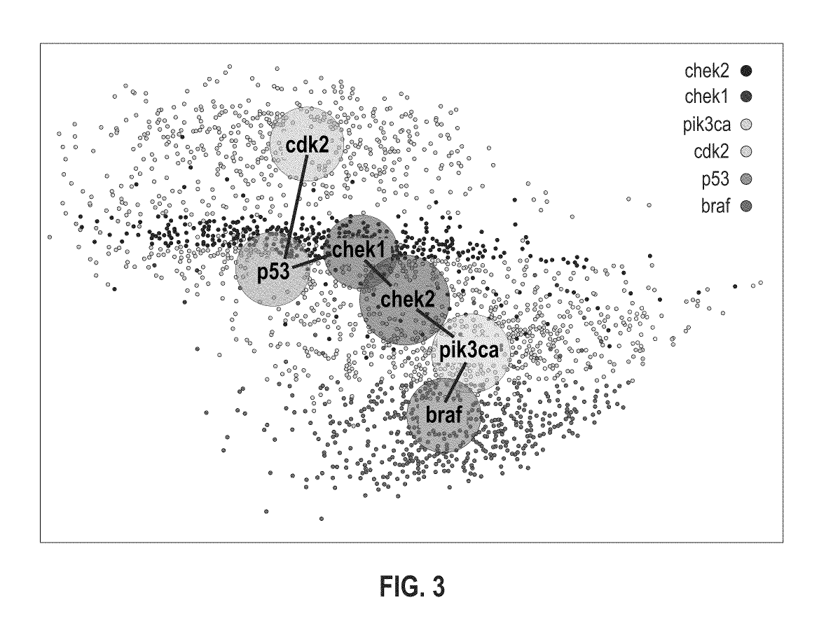

Next, a centroid is created around each gene by finding the average vector of all the vectors for that gene. The centroids are the larger bubbles shown in FIG. 3.

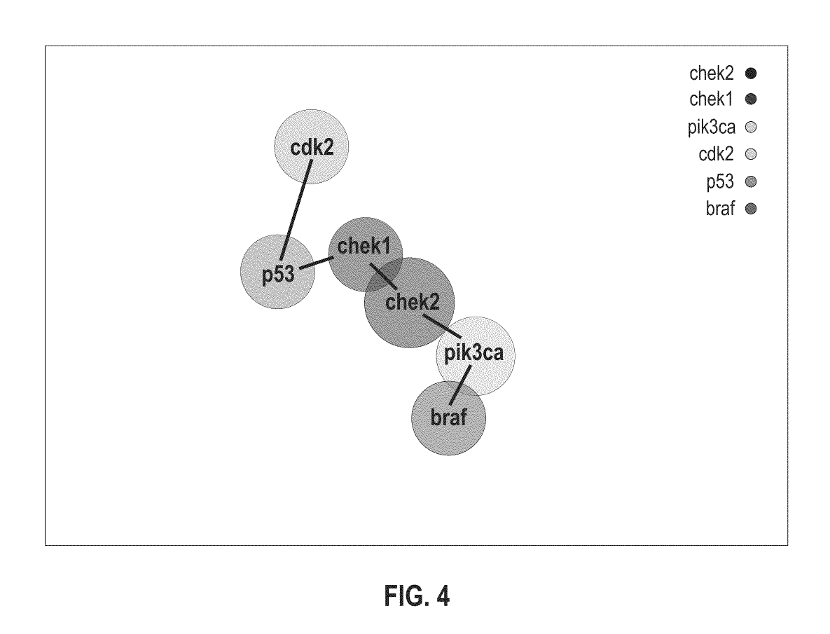

Finally, a network is created between the genes by creating a relative network graph that connects the genes that are most similar to each other, as shown in FIG. 4.

In the network depicted in FIG. 4, it may be surmised that the chek2 gene is a central gene in the pathway of colon cancer and, thus, is the key target to go after in designing a new drug to treat this disease.

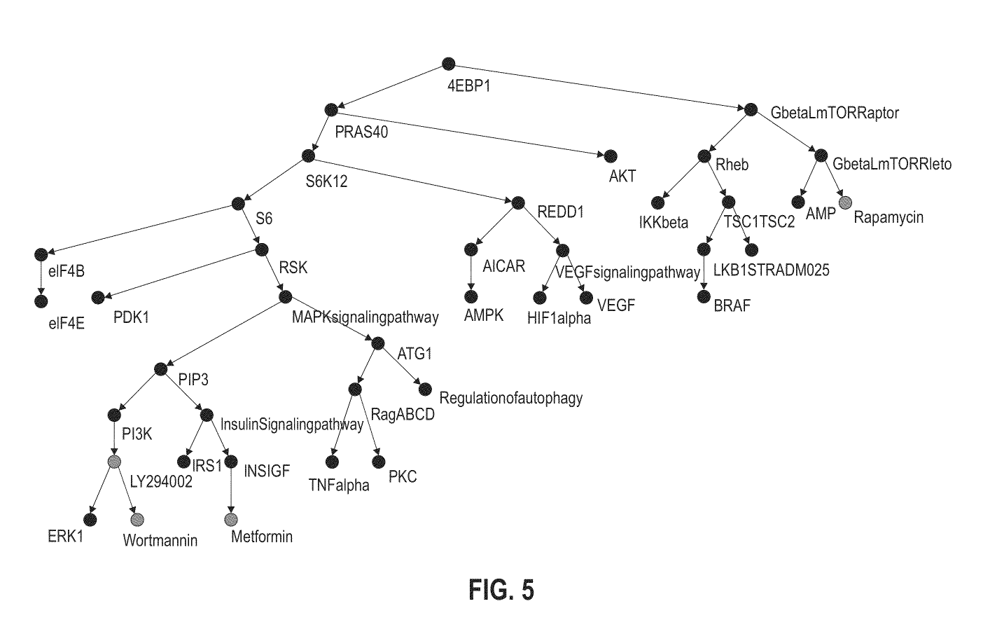

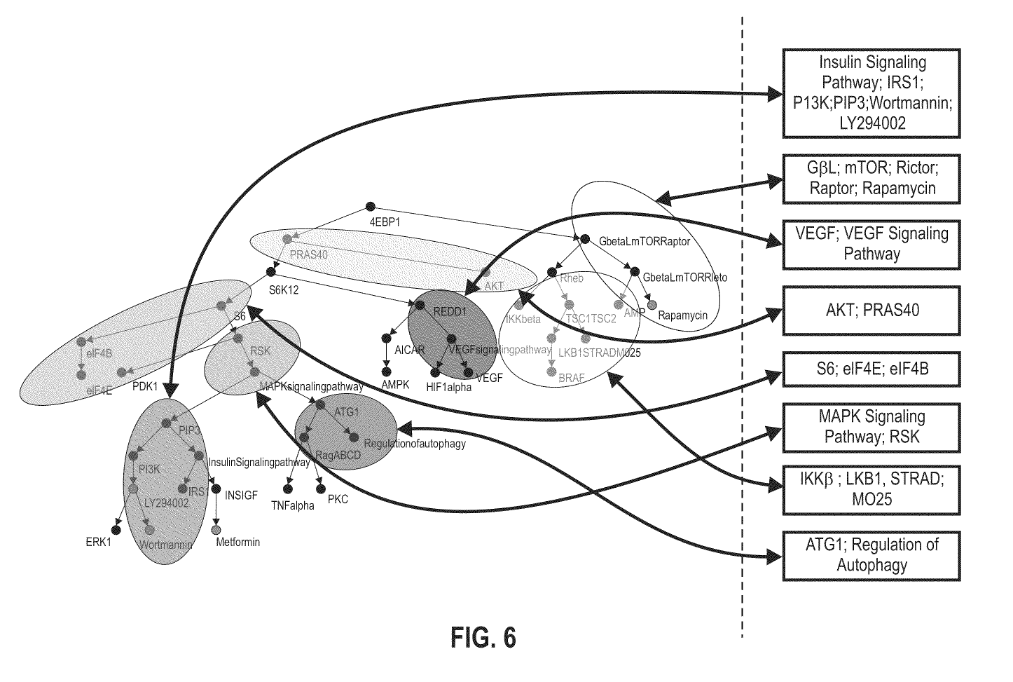

Another example shows the ability to recreate a pathway diagram (such as a KEGG pathway diagram) given only the entities. An example of such a diagram may be found in FIG. 3 of the article to Di Carlo et al. titled “A Systematic Analysis of a mi-RNA Inter-Pathway Regulatory Motif” (source: Journal of Clinical Bioinformatics, Vol. 3, No. 20, 2013). FIG. 5 depicts the graph of the set of entities shown in FIG. 3 of the Di Carlo et al. article as per the teachings of the present invention, where the graph is a biological network generated using the present invention's algorithm containing the same entities as FIG. 3 of the Di Carlo et al. article, generated over Medline® abstracts. FIG. 6 shows areas of correspondence between the manually curated mTOR signaling pathway shown in FIG. 3 of the Di Carlo et al. article (on the right of the dotted line in FIG. 6) and the automatically generated network from Medline® abstracts using the teachings of the present invention (to the left of the same dotted line in FIG. 6). A visual review indicates that the result shown in FIG. 6 overlaps with that of known regions of interest as in FIG. 3 of the Di Carlo et al. article. For example, it can be seen that node “PRAS40” and node “AKT” generated as per the teachings of the present invention (as shown in FIG. 5 and left-hand side of FIG. 6) maps well to the same components in FIG. 3 of the Di Carlo et al. article (as shown on the right-hand side of FIG. 6). Similarly, it can be seen that node “ATG1” and node “Regulationofautophagy” generated as per the teachings of the present invention (as shown in FIG. 5 and left-hand side of FIG. 6) maps well to the same components in FIG. 3 of the Di Carlo et al. article (as shown on the right-hand side of FIG. 6). The present invention, therefore, is able to substantially and accurately reproduce how the biological entities interact in the physical world based purely on text analysis of published content. Such outputs also provide proof of accuracy of the present invention's methodology to map what is known against which pathways are identified by the system/method.

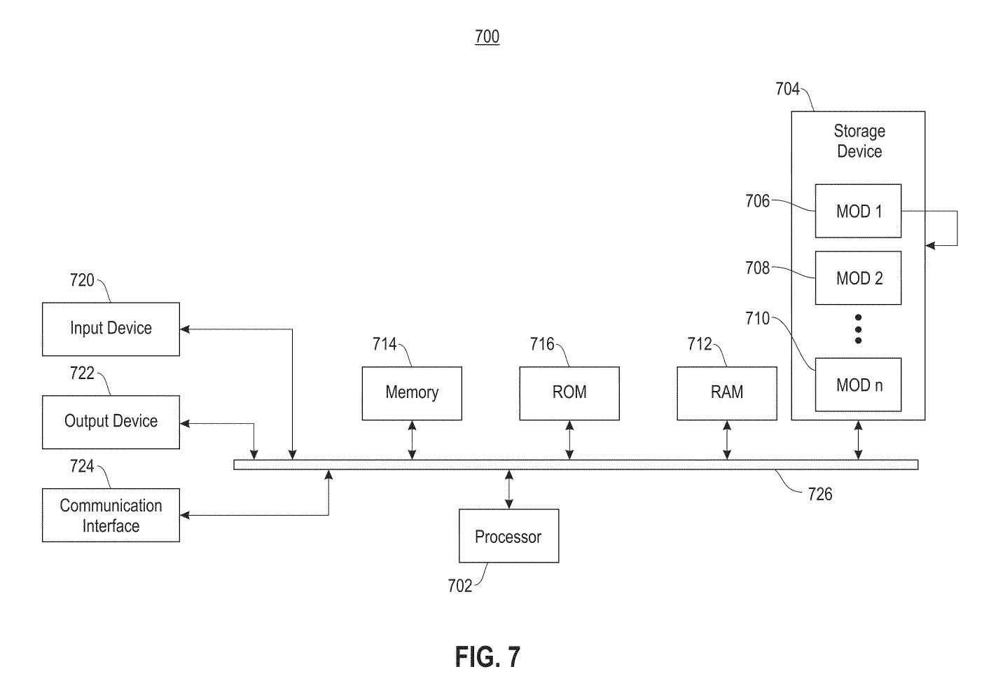

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 700 shown in FIG. 7 can practice all or part of the recited methods, can be a part of the recited systems, and/or can operate according to instructions in the recited non-transitory computer-readable storage media. With reference to FIG. 7, an exemplary system includes a general-purpose computing device 700, including a processing unit (e.g., CPU) 702 and a system bus 726 that couples various system components including the system memory such as read only memory (ROM) 716 and random access memory (RAM) 712 to the processing unit 702. Other system memory 714 may be available for use as well. It can be appreciated that the invention may operate on a computing device with more than one processing unit 702 or on a group or cluster of computing devices networked together to provide greater processing capability. A processing unit 702 can include a general purpose CPU controlled by software as well as a special-purpose processor.

The computing device 700 further includes storage devices such as a storage device 704 such as, but not limited to, a magnetic disk drive, an optical disk drive, tape drive or the like. The storage device 704 may be connected to the system bus 726 by a drive interface. The drives and the associated computer readable media provide nonvolatile storage of computer readable instructions, data structures, program modules and other data for the computing device 700. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 700, an input device 720 represents any number of input mechanisms, such as a microphone for speech, a touch-sensitive screen for gesture or graphical input, keyboard, mouse, motion input, speech and so forth. The output device 722 can also be one or more of a number of output mechanisms known to those of skill in the art. In some instances, multimodal systems enable a user to provide multiple types of input to communicate with the computing device 700. The communications interface 724 generally governs and manages the user input and system output. There is no restriction on the invention operating on any particular hardware arrangement and therefore the basic features here may easily be substituted for improved hardware or firmware arrangements as they are developed.

Logical operations can be implemented as modules configured to control the processor 702 to perform particular functions according to the programming of the module. FIG. 7 also illustrates modules MOD 1 706, MOD 2 708 through MOD n 710, which are modules controlling the processor 702 to perform particular steps or a series of steps. These modules may be stored on the storage device 704 and loaded into RAM 712 or memory 714 at runtime or may be stored as would be known in the art in other computer-readable memory locations.

Modules MOD 1 706, MOD 2 708 through MOD n 710 may, for example, be modules controlling the processor 802 to perform the following steps to discover a pathway among a set of biological and/or chemical entities: (a) provide documents about each of the biological and/or chemical entities; (b) create a vector space representation of the documents based on words and/or phrases occurring in the documents; (c) for each biological and/or chemical entity, create a centroid in the vector space based on the vectors corresponding to documents mentioning that entity; (d) create a relative distance network of the biological and/or chemical entities, in view of the centroids, thereby identify a particular pathway connecting the centroids; and (e) find at least one most connected centroid on the particular pathway, thereby identify a particular biological and/or chemical entity for further investigation, wherein the particular biological and/or chemical entity corresponds to the at least one most connected centroid.

Modules MOD 1 706, MOD 2 708 through MOD n 710 may, for example, be modules controlling the processor 702 to perform the following steps: (a) receiving a set of biological and/or chemical entities of interest, E; (b) identifying a document set, R, mentioning any biological and/or chemical entity, and/or a variant thereof, in E; (c) creating a dictionary, D, from common terms and/or phrases in documents of document set, R; (d) assigning each document in document set, R, a numeric vector using a vector space model based on said dictionary, D; (e) computing a centroid for each biological and/or chemical entity in E by averaging numerical vectors of documents in R mentioning that biological and/or chemical entity; (f) computing a distance matrix listing a distance (e.g., cosine distance) between pairs of centroids; (g) creating a relative neighborhood graph of biological and/or chemical entities in E based on said computed distance matrix, said relative neighborhood graph identifying a particular pathway connecting computed centroids; and (h) identifying, from said relative neighborhood graph, at least one most connected centroid and outputting biological and/or chemical entity associated with said at least one most connected centroid.

Modules MOD 1 706, MOD 2 708 through MOD n 710 may, for example, be modules controlling the processor 702 to perform the following steps: (a) receiving a set of biological and/or chemical entities of interest, E; (b) identifying a document set, R, mentioning any biological and/or chemical entity, and/or a variant thereof, in E; (c) creating a dictionary, D, from common terms and/or phrases in documents of document set, R; (d) assigning each document in document set, R, a numeric vector using a vector space model based on said dictionary, D; (e) computing a centroid for each biological and/or chemical entity in E by averaging numerical vectors of documents in R mentioning that biological and/or chemical entity; (f) computing a distance matrix listing a distance (e.g., cosine distance) between pairs of centroids; (g) creating a relative neighborhood graph of biological and/or chemical entities in E based on said computed distance matrix, said relative neighborhood graph identifying a particular pathway connecting computed centroids, the creating comprising: (g1) creating a candidate set, C, with biological and/or chemical entities in E; (g2) selecting an initial biological and/or chemical entity in C as a new node, e, to add to a tree and removing said new node, e, from C; (g3) comparing remaining biological and/or chemical entities in C to identify another biological and/or chemical entity to add to said tree with a shortest distance to existing nodes in said tree and adding said identified another biological and/or chemical entity to said tree and removing said another node from C, whereby step (g3) is iteratively repeated for other entries in C until there are no more entries in C, with all entries in C being added to said tree; and the resulting tree is output as part of said relative neighborhood graph; and (h) identifying, from said relative neighborhood graph, at least one most connected centroid and outputting entity associated with said at least one most connected centroid.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### CONCLUSION

The above embodiments show an effective implementation of a system, method and article of manufacture for inferring biological pathways from unstructured text analysis. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

1. A method for discovering a pathway among a set of biological and/or chemical entities, comprising:
a) providing documents about each of the biological and/or chemical entities;
b) creating a vector space representation of the documents based on words and/or phrases occurring in the documents;
c) for each biological and/or chemical entity, creating a centroid in the vector space based on the vectors corresponding to documents mentioning that biological and/or chemical entity;
d) creating a relative distance network of the biological and/or chemical entities, in view of the centroids, thereby identifying a particular pathway connecting the centroids; and
e) finding at least one most connected centroid on said particular pathway, thereby identifying a particular biological and/or chemical entity for further investigation, wherein said particular biological and/or chemical entity corresponds to said at least one most connected centroid.

2. The method of claim 1, wherein, prior to step (b), documents matching more than one biological and/or chemical entity are removed.

3. The method of claim 1, wherein biological and/or chemical entities having less than a pre-defined threshold number of documents are removed.

4. The method of claim 1, wherein said biological and/or chemical entities are selected from the group consisting of human genes and proteins.

5. The method of claim 1, wherein said documents are provided in response to a query.

6. The method of claim 1, wherein said documents are provided over a network.

7. The method of claim 6, wherein said network is any of the following: local area network (LAN), wide area network (WAN), the Internet, or cellular network.

8. A method comprising:
a. receiving a set of biological and/or chemical entities of interest, E;
b. identifying a document set, R, mentioning any biological and/or chemical entity, and/or a variant thereof in E;
c. creating a dictionary, D, from common terms and/or phrases in documents of document set R;
d. assigning each document in document set R a numeric vector using a vector space model based on said dictionary D;
e. computing a centroid for each biological and/or chemical entity in E by averaging numerical vectors of documents in R mentioning that biological and/or chemical entity;
f. computing a distance matrix listing a distance between pairs of centroids;
g. creating a relative neighborhood graph of biological and/or chemical entities in E based on said computed distance matrix, said relative neighborhood graph identifying a particular pathway connecting computed centroids; and
h. identifying, from said relative neighborhood graph, at least one most connected centroid and outputting biological and/or chemical entity associated with said at least one most connected centroid.

9. The method of claim 8, wherein said step of creating said relative neighborhood graph comprises:
g1. creating a candidate set, C, with biological and/or chemical entities in E;
g2. selecting an initial biological and/or chemical entity in C as a new node, e, to add to a tree and removing said new node e from C;
g3. comparing remaining biological and/or chemical entities in C to identify another biological and/or chemical entity to add to said tree with a shortest distance to existing nodes in said tree and adding said identified another biological and/or chemical entity to said tree and removing said another node from C,
wherein step g3 is iteratively repeated for other entries in C until there are no more entries in C, with all entries in C being added to said tree; and resulting tree is output as part of said relative neighborhood graph.

10. The method of claim 8, wherein said distance between pairs of centroids is a cosine distance.

11. The method of claim 8, wherein, prior to step (c), documents in R matching more than one biological and/or chemical entity in E are removed from R.

12. The method of claim 8, wherein, prior to step (c), biological and/or chemical entities in E having less than a pre-defined threshold number of documents are removed from E.

13. The method of claim 8, wherein said method comprises displaying said computed centroids and documents in document set, R, via a scatter plot graph.

14. The method of claim 8, wherein said biological and/or chemical entities are selected from the group consisting of human genes and proteins.

15. The method of claim 8, wherein said document set R is identified in response to a query.

16. The method of claim 8, wherein said document set R is identified over a network.

17. The method of claim 16, wherein said network is any of the following: local area network (LAN), wide area network (WAN), the Internet, or cellular network.

18. A non-transitory, computer accessible memory medium storing program instructions for discovering a pathway among a set of biological and/or chemical entities, wherein the program instructions are executable by a processor to:
a. receive a set of biological and/or chemical entities of interest, E;
b. identify a document set, R, mentioning any biological and/or chemical entity, and/or a variant thereof in E;
c. create a dictionary, D, from common terms and/or phrases in documents of document set R;
d. assign each document in document set R a numeric vector using a vector space model based on said dictionary D;
e. compute a centroid for each biological and/or chemical entity in E by averaging numerical vectors of documents in R mentioning that biological and/or chemical entity;
f. compute a distance matrix listing a distance between pairs of centroids;
g. create a relative neighborhood graph of biological and/or chemical entities in E based on said computed distance matrix, said relative neighborhood graph identifying a particular pathway connecting computed centroids; and
h. identify, from said relative neighborhood graph, at least one most connected centroid and outputting biological and/or chemical entity associated with said at least one most connected centroid.

19. A system for discovering a pathway among a set of biological/chemical entities, the system comprising:
one or more processors; and
a memory comprising instructions which, when executed by the one or more processors, cause the one or more processors to:
a. receive a set of biological and/or chemical entities of interest, E;
b. identify a document set, R, mentioning any biological and/or chemical entity, and/or a variant thereof in E;
c. create a dictionary, D, from common terms and/or phrases in documents of document set R;
d. assign each document in document set R a numeric vector using a vector space model based on said dictionary D;
e. compute a centroid for each biological and/or chemical entity in E by averaging numerical vectors of documents in R mentioning that biological and/or chemical entity;
f. compute a distance matrix listing a distance between pairs of centroids;
g. create a relative neighborhood graph of biological and/or chemical entities in E based on said computed distance matrix, said relative neighborhood graph identifying a particular pathway connecting computed centroids; and
h. identify, from said relative neighborhood graph, at least one most connected centroid and outputting biological and/or chemical entity associated with said at least one most connected centroid.
